(19) United States
(12) Patent Application Publication
(10) Pub. No.: US 2008/0254248 A1
(43) Pub. Date: Oct. 16, 2008

(54) Bonding Intermediate for Silicone Coated Textile

(75) Inventors: Carlos Saiz, Chambery (FR); Geraldine Martin, La Tour Du Pin (FR)

Correspondence Address: CANTOR COLBURN, LLP, 20 Church Street, 22nd Floor, Hartford, CT, 06103, US

(73) Assignee: TISSAGE ET ENDUCTION SERGE FERRARI SA, SAINT JEAN DE SOUDAIN (FR)

(21) Appl. No.: 12/089,171

(22) PCT Filed: Oct. 3, 2006
(86) PCT No.: PCT/FR06/50989

§ 371 Date: May 8, 2008

(30) Foreign Application Priority Data
Oct. 3, 2005 (FR) 0552988

(51) Int. Cl. B32B 33/00

(52) U.S. Cl. 428/41.3

(57) ABSTRACT

Bonding intermediate between two textiles each having a coating layer of silicone-based polymer, the said intermediate comprising a composition based on a non-crosslinked silicone elastomer, and a release film positioned on a first side of the said intermediate, characterized in that it has the shape of a planar rectilinear section of a strip based on the said non-crosslinked silicone elastomer, and in that it comprises a translucent film provided on the second side of the strip.

### TECHNICAL FIELD

The invention relates to the field of technical textiles, more particularly coated or lined textiles. It relates more specifically to coated textiles whereof the coating layer is silicone-based, appreciated in particular for their high temperature behaviour, their resistance to chemical attack and to ultraviolet radiations. The invention relates more particularly to a bonding intermediate used to assemble a plurality of widths of such textiles. The invention selves in particular to facilitate the bonding operations, and to improve the quality of the assembly.

### PRIOR ART

In general, coated textiles based on silicone polymers are known for their excellent resistance to heat, and particularly to fire, and for their resistance to chemical attack and ultraviolet radiation. This type of textile is therefore frequently used in difficult temperature conditions. For this purpose, the textile core may advantageously, but not exclusively, be prepared on the basis of glass yarns, known for their good thermal properties.

A problem generally arises when joining various pieces of coated fabrics, particularly for preparing very wide products.

Thus, stitching techniques have widely been used, but they have a number of drawbacks. In fact, the stitching operations create holes which are incipient tears. Furthermore, the stitches do not form a really sealed barrier. Moreover, the stitching operations are relatively delicate, because of the need to overcome the friction of the stitching yarn with the polymerized silicone material, which opposes the sliding of the stitching yarn. This is why use is frequently made of yarns based on polytetrafluoroethylene, known for their low friction coefficient.

However, these yarns, although having good tensile strength, are relatively costly.

Among the other drawbacks of stitching, mention can also be made of the fact that the passage of the yarn through the textile breaks a number of core filaments, reducing the mechanical strength thereof.

Furthermore, the holes created by the stitching yarns constitute moisture entry points, which can cause a deterioration of the mechanical properties of the glass yarns, and hence of the textile in general.

Other assembly techniques are also employed, consisting in the application of a paste or liquid bonding process. Such a process involves the cold deposition of a mastic on one of the parts to be assembled and then in apposing the other part to be assembled while applying pressure and temperature. In the liquid process, the liquid adhesive is deposited, and the application of pressure serves to make the fabrics adhere together.

However, the conditions in which the bonding must take place are relatively restrictive, because the mastic or liquid adhesive must be applied in a dust-free atmosphere. Moreover, the mastic or liquid adhesive generally create smudges which deteriorate the visual appearance of the bonding zone. Moreover, the application of pressure to cause the bonding must be relatively long to ensure effective bonding.

Furthermore, the mastic or liquid adhesive cannot be applied to coated openwork fabrics, for example prepared on the basis of woven coated grids or yarns. The mastic or liquid adhesive are in fact useless in this configuration, because they collect in the openings of the fabric. The contact surfaces between the two textiles are thus not controlled.

Another technique for preparing such an assembly consists in using a bonding intermediate consisting of a composition belonging for example to the family of hot vulcanizable elastomers (HVE). Such an intermediate is thus positioned on the junction zone between the sheets to be assembled. The application of a pressure and high temperature then causes the crosslinking of the silicone of the intermediate which reacts and permits the adhesion with the silicone present in each of the two coating layers of the two opposing textiles.

Examples of a suitable composition for this type of bonding intermediate are described in documents EP 0 219 075 and EP 0 214 631. However, difficulties have arisen during the handling of such types of interface insofar as the non-crosslinked silicone has a highly deformable consistency, and therefore no real strength. This is why, as described in document EP 0 219 075, the non-crosslinked silicone is generally combined with a core having a strength and more particularly a resistance to elongation, which may be a woven core. The non-crosslinked silicone is also protected by a sheet of release material, itself enabling it to be wound on itself during transport.

This solution nevertheless has a number of drawbacks. The presence of a core inside the non-crosslinked silicone forms an interface zone which may constitute a weakness of the final structure. Furthermore, the non-crosslinked silicone is stored in the form of strips wound on themselves, and the winding/unwinding operations inevitably cause dimensional variations in the layer of non-crosslinked silicone. This causes a non-uniformity of the mechanical properties of the assembly, wide variations in the cross sections, and therefore the formation of very high stress zones in certain parts of the assembly.

Furthermore, the chemical properties of the non-crosslinked silicone tend to change over time, particularly when it is exposed to hot environments, so that the solidity of the junction may vary according to the age of the non-crosslinked silicone strip used. This feature demands major precautions during transport and storage, and in particular the ability to identify the use-before-date on the elastomer itself.

In the case in which the non-crosslinked silicone strip is equipped with a peelable release film, and is packed wound in an Archimedes spiral, the removal of the peelable film also causes elongations of the bonding intermediate, with repercussions on the uniformity of the mechanical properties of the assemblies.

All of these drawbacks make these solutions difficult to use for very large scale, long service life structures, as found in particular in the preparation of structures having a textile architecture.

One of the objectives of the invention is therefore to permit the assembly operations of the silicone coated textiles with a bonding intermediate which has properties as constant as possible, and whereof the handling does not cause any deformation detrimental to the quality of the assembly, and above all, being easy to use and position accurately.

### SUMMARY OF THE INVENTION

The invention therefore relates to a bonding intermediate usable to join two textile sheets each having a coating layer of silicone-based polymer. In a manner known per se, this bonding intermediate comprises a composition based on a non-crosslinked silicone elastomer. To allow its handling and protection, the bonding intermediate is also provided with a release film positioned on one of its sides.

According to the invention, the bonding intermediate has the shape of a planar rectilinear section of a strip based on a non-crosslinked silicone elastomer composition. This rectilinear section also comprises a translucent film provided on the second side of the strip, that is, the side opposite the side that receives the release film.

In other words, the invention consists in using a bonding intermediate having the shape of a sufficiently short stripped segment, that is no more than a few meters long, in order to be handled without excessive deformation. This serves to avoid any change in the thickness or width of the strip after application which could have repercussions of the uniformity of the properties of the junction, which are observed on bonding intermediates wound on themselves.

The handling of the strip is thus facilitated, because the two sides are protected by two films, which are of different types. These two films are present as long as the strip is not positioned at the junction zone, thereby ensuring protection of the non-crosslinked silicone, which thereby preserves its chemical properties.

Furthermore, the handling operations during the placement of the bonding intermediate on one of the textile sheets to be joined are improved, because the translucent film serves to visualize the zone of the textile sheet through the non-crosslinked silicone composition. The characteristic strip is thereby positioned more accurately, in particular in order to avoid any misalignment at the junction. The presence of the transparent film also serves as a mechanical support to avoid any elongation of the non-crosslinked silicone strip, when the release strip film has already been withdrawn to position the bonding interface on the appropriate zone of the textile sheet.

Advantageously, the translucent film may be based on a thermoplastic polyester or, more generally, on a transparent polymer, having a low elongation rate. In fact, such a film serves to ensure dimensional stability of the bonding intermediate during handling operations, and therefore preservation of the dimensions of the non-crosslinked silicone layer.

Complementarily, the release film may be prepared on the basis of a thermoplastic polyethylene or, more generally, with a material having low adhesive power to the non-crosslinked silicone.

This low adhesive power can be improved by using a film which has an embossed surface or, in general, a textured surface in order to limit the contact area with the non-crosslinked silicone. Such a release film is advantageous, because it avoids any pullout or distortion of the non-crosslinked silicone layer when it is detached therefrom.

In a particular embodiment of the invention, the composition of the characteristic strip may further comprise heat dissipating elements. These additional elements may either be embedded in the thickness of the non-crosslinked silicone layer, or present on one and/or the other of the sides of this non-crosslinked silicone layer. These heat dissipating elements may be selected to absorb certain radiations, particularly in the infrared spectrum, and more precisely, in the 800 to 1200 nanometres band. These elements serve to improve the kinetics of the cross-linking reaction. These additional elements may be selected to visualize the completion of the cross-linking reaction of the silicone of the bonding intermediate. In fact, by employing thermochromic pigments, the temperature rise in the bonding intermediate during a sufficient period serves to make the colour of these pigments evolve, and in consequence, to authenticate the fact that the bonding intermediate has received a sufficient quantity of heat to guarantee complete cross-linkage.

In a particular embodiment of the invention, the bonding intermediate may also comprise marking indications provided on one and/or the other of these sides. These indications may, for example, have the form of reference lines, designed to guide the placement of the second sheet to be joined to the first. In other words, after the placement of the bonding intermediate on the first sheet, a marking line remains visible on the topside of the bonding intermediate, and serves to position the border of the second sheet very accurately.

These marking indications may also serve as identification data for the purpose of traceability or identification. In other words, the type of marking may be visible by transparency after the assembly of sufficiently translucent coated textiles, typically based on glass and white silicone. This makes it possible to detect whether a joining operation has been performed after a use-before-date apposed on the bonding intermediate.

In practice, the bonding intermediate may have the shape of independent sections, or the shape of a string of straight rectilinear sections connected to one another, and folded on one another. In this latter case, the string may comprise incipient cuts in the bonding zones between adjacent sections, thereby serving to cut the appropriate length of the bonding intermediate, when a plurality of elementary sections are needed to prepare a very long assembly.

### BRIEF DESCRIPTION OF THE FIGURES

The implementation of the invention and the advantages thereof will appear clearly from the description of the embodiments that follow in conjunction with the appended figures in which:

FIG. 1 is a brief perspective view of a bonding intermediate according to the invention, shown with the films partially separated from the non-crosslinked silicone layer.

FIG. 2 shows a cross section of the bonding intermediate of FIG. 1.

FIG. 3 is a brief perspective view of the non-crosslinked silicone layer of the bonding intermediate of FIG. 1, shown alone.

FIGS. 4 and 5 are plan views of the two coated textiles sheets during the joining operations.

FIG. 6 is a perspective view of an alternative embodiment, showing a string of sections.

### IMPLEMENTATION OF THE INVENTION

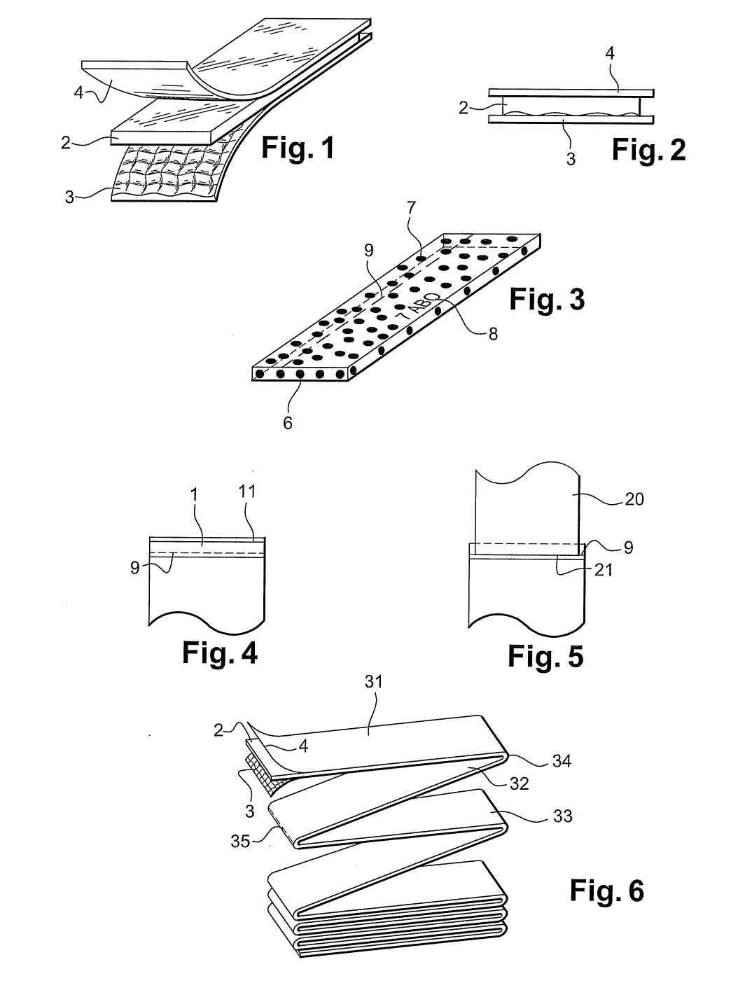

As shown in FIG. 1, the bonding intermediate according to the invention may have the shape of a planar and rectilinear section (1). This section (1) comprises an assembly of three layers, that is a first main layer (2) constituting the bonding intermediate as such, covered on each of its sides by two films.

The underside of the layer (2) is in contact with a first release film (3). The upperside of the intermediate layer (2) is covered with a second transparent film (4).

The main material constituting the central layer (2) is based on non-crosslinked silicone elastomer. Numerous materials may be used, with different compositions and formulations according to the type of textile sheet to be assembled. In a particular embodiment of the invention, good results have been obtained using a hot vulcanizable silicone elastomer composition as the non-crosslinked silicone. Such compositions are known to generally consist of very high molecular weight polydimethylsiloxane, combined with reinforcing mineral fillers, and with various additives allowing their hardening by the cross-linking of the polymer chains, and even promoting their bonding to the supports on which they are apposed. These materials are in a form having a certain consistency, but deformable under the action of a stress. They are hot vulcanizable to produce a material having a rubbery appearance and mechanical strength. Their shaping requires pressures in the range of a few tens of bar, and their vulcanization typically occurs in a few minutes, at temperatures of about 100 to 180° C.

The film shown (3) under the underside of the non-crosslinked silicone layer (2) may typically be based on polyester, or more generally any material having a very low adhesion coefficient with regard to the non-crosslinked silicone. As shown, this film may have a texture or a surface condition that limits the area of the contact zone with the central layer (2), also for the purpose of limiting the adhesive force thereof.

The film (4) provided on the upperside of the non-crosslinked silicone layer (2) may typically be based on polyester, or any other transparent material, having a low elongation rate under the effect of a tensile load having a reasonable amplitude, observed during handling and peeling operations. Typically, this film may have a thickness of about 30 microns. Obviously, other materials may be employed, insofar as the release film (3) adheres less well to the silicone (2) than the protective film (4), so as to be detached first.

According to another feature of the invention, and as shown in FIG. 3, the non-crosslinked silicone layer (2) may comprise various additives, which are heat dissipating elements. These elements (6) may in particular be embedded in the mass of the non-crosslinked silicone composition, so as to diffuse and/or radiate the heat in the body of the material to be cross-linked. These additional elements (7) may also be placed on the surface, or immediately next to the surface of the non-crosslinked silicone layer (2).

In this case, the cross-linking is preferably assisted close to the coating layer of the textile sheet to be joined (not shown). For example, these additional elements may consist of a powder of fine particles absorbing the radiation in the infrared spectrum. These particles are selected to have a chemical behaviour that does not deteriorate the properties of the non-crosslinked silicone. Among the many examples that have proved satisfactory, use can be made of a pigment powder based on antimony and tin oxide, like for example the product Minatec 230A IR from Merck.

According to one feature of the invention, and as shown in FIG. 3, the non-crosslinked silicone layer (2) may have a number of marking indications (8) for coding the bonding intermediate used, for its identification for the purpose of traceability. This marking may therefore be useful before the use of the bonding intermediate, to identify the age of the section concerned. This marking (8) may also be advantageous after use, insofar as the sheet to be joined is translucent. In fact, by backlighting, it is possible for the indications (8) to be visible, thereby serving to identify the make of the manufacturer or some indication of the date of the joining operations.

According to another feature of the invention, the non-crosslinked silicone layer (2) may also include other types of marking, such as in particular a positioning line (9), useful during these joining operations, as described in FIGS. 4 and 5.

Thus, the bonding intermediate according to the invention is used according to the following procedure.

Firstly, the release film (3) is peeled off, that is detached from the combination formed of the non-crosslinked silicone layer (2) and the upper film (4). The film is peeled without deformation of the non-crosslinked silicone layer (2), thanks to the low adhesive power of the film (3). The bonding intermediate is handled without deformation thanks to the presence of the upper film (4), which cannot be elongated.

As shown in FIG. 4, the bonding intermediate is then placed on a border of a textile sheet (10) to be joined. The bonding intermediate (1) is positioned so that it projects slightly beyond the border (11) of the sheet (10), in order to permit part of the non-crosslinked silicone to come into contact with the edge of the textile sheet (10) after joining.

This positioning is possible thanks to the transparency of the upper film (4) and its good mechanical strength.

Subsequently, this upper film (4) is detached from the non-crosslinked silicone layer (2). Due to the adhesion between the silicone layer of the textile sheet (10) and the non-crosslinked silicone layer, the upper film is peeled off without deformation of the characteristic layer (2). FIG. 4 shows that the marking line (9) is visible, and serves to allow the positioning of the second textile sheet (20).

Thus, as shown in FIG. 5, the second textile sheet (20) is positioned on the bonding intermediate, so that its border (21) coincides with the marking line (9) present on the bonding intermediate. In this way, a fraction of a non-crosslinked silicone layer remains uncovered, in order to overlap the edge of the second textile sheet (20).

Obviously, it is possible to place on the border of the first textile sheet as many sections (1) as necessary to ensure a continuous junction. To prevent the deterioration of the non-crosslinked silicone layer, the various sections are placed in succession, before their upper film (4) is peeled off.

Subsequently, the cross-linking reaction is carried out by the application of the necessary temperature and pressure conditions.

In the alternative shown in FIG. 6, the bonding intermediate has the shape of a string of a plurality of rectilinear sections (31-33) folded on themselves. These various sections are joined thanks to the release film (3) and the protective film (4) which are continuous. The silicone layer (2) has incipient cuts (35) in the form shown, at the folds (34) between sections, to facilitate the separation of the sections, when it is necessary to obtain a predefined length. These incipient cuts may also be provided on the release (3) and protective (4) films, to permit the separation in individual sections as required.

It appears from the above that the bonding intermediate according to the invention has many advantages, and particularly that of permitting simple and safe handling, because it limits the exposure of the non-crosslinked silicone, and prevents any deformation thereof.

Furthermore, the positioning of this bonding intermediate is extremely accurate thanks to the use of a transparent upper film, and the possibility of incorporating marking indications. These indications also serve to ensure the traceability and identification functions.

1. Bonding intermediate between two textiles each having a coating layer of silicone-based polymer, the said intermediate comprising a composition based on a non-crosslinked silicone elastomer, and a release film positioned on a first side of the said intermediate, the bonding intermediate comprising a shape of at least one planar rectilinear section of a strip based on the said non-crosslinked silicone elastomer, and a translucent film provided on the second side of the strip.

2. Bonding intermediate according to claim 1, wherein the translucent film is based on a thermoplastic polyester.

3. Bonding intermediate according to either of claim 1, wherein the release film is based on a thermoplastic polyethylene.

4. Bonding intermediate according to claim 1, wherein the release film has an embossed surface in contact with the strip.

5. Bonding intermediate according to claim 1, wherein the composition of the strip further comprises heat dissipating elements.

6. Bonding intermediate according to claim 1, wherein the strip further comprises heat dissipating elements provided on the first and/or second side of the strip.

7. Bonding intermediate according to claim 1, wherein the strip further comprises a marking provided on the first and/or second side of the strip.

8. Bonding intermediate according to claim 1, comprising a plurality of rectilinear sections connected to one another and folded on one another.

9. Bonding intermediate according to claim 8, comprising incipient cuts in the bonding zones between adjacent sections.
